(19) United States
(12) Patent Application Publication
(10) Pub. No.: US 2015/0124723 A1
(43) Pub. Date: May 7, 2015

(54) WIRELESS COMMUNICATION APPARATUS, WIRELESS COMMUNICATION METHOD, PROCESSING APPARATUS, AND PROGRAM

(71) Applicant: Sharp Kabushiki Kaisha, Osaka-shi, Osaka (JP)

(72) Inventor: Hideo Namba, Osaka-shi (JP)

(21) Appl. No.: 14/398,242

(22) PCT Filed: Apr. 24, 2013
(86) PCT No.: PCT/JP2013/062040

§ 371 Date: Oct. 31, 2014

(30) Foreign Application Priority Data
May 2, 2012 (JP) 2012-105021

(51) Int. Cl. H04W 74/08

(52) U.S. Cl. CPC H04W 74/0816
USPC 370/329

(57) ABSTRACT

A wireless communication apparatus is used in a wireless communication system in which carrier sensing, and an exchange of a transmission request signal and a transmission permission signal are performed in order to perform wireless communication. The wireless communication apparatus includes: a reception unit that is capable of receiving multiple signals simultaneously; and a control unit that generates an acknowledgement response to a data signal on a priority basis in a case where the data signal and a transmission request signal are included in signals received by the reception unit.

### TECHNICAL FIELD

The present invention relates to a wireless communication technology.

### BACKGROUND ART

As an access method used when constructing a wireless network, a CSMA/CA (Carrier Sense Multiple Access/Collision Avoidance) technique is widely used, and also used in IEEE802.11 or the like, which is one of wireless LAN standards. The CSMA/CA is a technique in which carrier sense is performed in advance of transmission and then random backoff is used to avoid a collision. Furthermore, in some cases, an exchange of an RTS (Request To Send, also referred to as a transmission request)/a CTS (Clear To Send, also referred to as transmission permission) is involved so as to solve a hidden terminal problem, and, in IEEE802.11, the CSMA/CA is used including an RTS/CTS exchange.

An example of communication performed by using this access method used in IEEE802.11 will be described using FIG. 8. FIG. 8 illustrates, by using a timing chart, an example of the case where an AP (Access Point, also referred to as a wireless control apparatus) communicates with two STAs (STAtion, it is also referred to as a wireless terminal apparatus), communication is performed from a STA1 to the AP, and immediately after that, communication is performed from a STA2 to the AP. First, the STA1 waits until transmission 801 performed by the AP or either of the STAs is completed. After the completion of the transmission, the STA1 further waits for a DIFS (Distributed coordination function InterFrame Space) period 802 and transmits an RTS 803 to the AP. A DIFS is a waiting period for a DCF (Distributed Coordination Function), is configured to a basic period longer than a SIFS, which will be described later, and is also the period to which a random backoff period has been added. At the time of transmission of this RTS 803, a NAV (Network Allocation Vector) (NAV1 820) is configured so that the other STA does not perform transmission for a predetermined period after the RTS 803 transmission. A NAV is also referred to as a transmission inhibition period, and is configured to a period required for transmission of a CTS, transmission of data, and transmission of an ACK (ACKnowledge, it is also referred to as an acknowledgement response) to the data. The other STA having received the NAV is inhibited from performing transmission for the configured period.

In the case where the AP has been able to receive the RTS 803 successfully, the AP considers that no STAs have used a radio resource, waits for a SIFS (Short InterFrame Space) period 804, and transmits a CTS 805 to the STA1. A SIFS is a minimum specified period for subsequent transmission to be performed by the AP or each STA, and is a period specified so that when transmission of an important packet, such as an ACK, an RTS, or a CTS is performed, the other STA or the like does not interrupt the transmission. A DIFS or the like for starting DCF access is specified to be a period longer than the SIFS, thereby enabling an important packet to be transmitted on a priority basis. At the time of transmission of the CTS 805, the AP also configures a NAV. The NAV to be configured by the AP is configured to a value obtained by subtracting a period required for transmission and reception of the RTS 803 from the period configured in the RTS 803, that is, a value that is substantially the same as the value configured in the RTS 803. This enables a STA that has been unable to receive an RTS to acquire substantially the same NAV.

Subsequently, the STA1 having received the CTS 805 considers that it has acquired a transmission permission, waits for a SIFS period 806, and then transmits DATA1 807 to the AP. The AP having received the DATA1 807 waits for a SIFS period 808, and transmits an ACK1 809 to the STA1. The STA1 having received the ACK1 determines that transmission of the DATA1 807 has been completed, and does not perform subsequent transmission. The STA2 receives communications between the STA1 and the AP while waiting for a period of the NAV1 820, waits for a DIFS period 810 from a point in time when all transmission is completed, and transmits an RTS 811 to the AP.

At the time of transmission of the RTS 811, a period required for transmission of a CTS, transmission of data, and transmission of an ACK to the data is configured as a NAV2 821. In the case where the AP has been able to receive the RTS 811 successfully, the AP considers that no STAs have used a radio resource, waits for a SIFS period 812, and transmits a CTS 813 to the STA2. At the time of transmission of the CTS2, in the same manner as described above, a period which is obtained by subtracting a period taken to receive the RTS and which is substantially the same as that of the NAV2 is configured as a NAV. The STA2 having received the CTS 813 considers that it has acquired a transmission permission, waits for a SIFS period 814, and then transmits DATA2 815 to the AP. The AP having received successfully the DATA2 815 waits for a SIFS period 816, and transmits an ACK2 817 to the STA2. The STA2 having received the ACK2 817 determines that transmission has been completed, and does not perform subsequent transmission. Then, when a DIFS period 818 elapses, other DCF access 819 can be made.

The above procedure enables avoidance of a collision between packets, and data transmission between multiple STAs in IEEE802.11.

Aside from this, in order to make effective use of radio waves, research on a MU-MIMO (Multi User-Multi Input Multi Output) technology in which multiple STAs simultaneously perform transmission by using spatial multiplexing has advanced. In IEEE802.11, since the above-described DCF access is performed, basically, multiple STAs do not simultaneously perform transmission. However, there is a suggestion for MU-MIMO in which an opportunity to perform simultaneous transmission is acquired by using a technique such as described in NPL 1 or PTL 1.

### CITATION LIST

### Patent Literature

PTL 1: Japanese Unexamined Patent Application Publication No. 2011-217234

### Non Patent Literature

NPL 1: Azadeh Ettefagh, Marc Kuhn and Armin Wittneben, “Performance of a Clueter-Based MAC Protocol in Multiuser MIMO Wireless LANs,” 2010 Internatinal ITG Workshop on Smart Antennas.

### SUMMARY OF INVENTION

### Technical Problem

Use of a technique of NPL 1 or PTL 1 enables multiple STAs to simultaneously acquire a transmission opportunity.

However, in order to reduce overhead of an RTS/CTS exchange, IEEE802.11 defines that when transmission of short data is performed, data transmission is performed without an RTS/CTS exchange. In the technique of NPL 1 or PTL 1, the case where transmission of an RTS coincides with transmission of data occurs, these are received, and then an ACK or a CTS has to be transmitted after a SIFS. In the case where only one is transmitted, retransmission of the other occurs, and there is a problem in that a transmission data collision occurs. In addition, in the case where the ACK is transmitted, if a period specified as a NAV configured in the RTS is long, there is also a problem in that another STA having received this cannot start subsequent transmission and time is wasted.

An object of the present invention is to reduce the occurrence of a data collision in the case where data and an RTS are simultaneously transmitted. In addition, an object is to reduce the occurrence of wasted time in the case where data and an RTS are simultaneously transmitted.

### Solution to Problem

An aspect of the present invention provides a wireless communication apparatus used in a wireless communication system in which carrier sensing, and an exchange of a transmission request signal and a transmission permission signal are performed in order to perform wireless communication. The wireless communication apparatus includes: a reception unit that is capable of receiving multiple signals simultaneously; and a control unit that generates an acknowledgement response to a data signal on a priority basis in a case where the data signal and a transmission request signal are included in signals received by the reception unit.

In a case where a transmission inhibition period included in the transmission request signal is larger than a predetermined value, preferably, after the acknowledgement response to the data signal has been generated, the control unit transmits a transmission permission signal to the transmission request signal.

At a time when the control unit transmits the transmission permission signal, preferably, the control unit includes, in the transmission permission signal, a value obtained by subtracting a predetermined value from the transmission inhibition period included in the transmission request signal, and transmits the transmission permission signal.

Another aspect of the present invention provides a wireless communication method in which carrier sensing, and an exchange of a transmission request signal and a transmission permission signal are performed in order to perform wireless communication. The wireless communication method includes the step of, in a case where signals including a data signal and a transmission request signal are received, generating an acknowledgement response to the data signal on a priority basis.

The present invention is a program for causing a computer to execute the above-described wireless communication method.

Furthermore, the present invention is a processing apparatus that causes a wireless communication apparatus to execute a predetermined function, and the wireless communication apparatus is used in a wireless communication system in which a carrier sense, and an exchange of a transmission request signal and a transmission permission signal are performed in order to perform wireless communication. The predetermined function includes: a reception function of being capable of receiving multiple signals simultaneously; and a control function of, in a case where a data signal and a transmission request signal are included in signals received in the reception function, generating an acknowledgement response to the data signal on a priority basis.

Furthermore, the present invention is a wireless communication apparatus used in a wireless communication system in which a carrier sense and an exchange of a transmission request signal and a transmission permission signal are performed in order to perform wireless communication. The wireless communication apparatus includes a control unit that performs control so that, after a transmission request signal has been transmitted, even in a case where a signal in which a wireless communication apparatus other than the wireless communication apparatus itself is configured as a destination is received, retransmission is not performed for a predetermined period.

The predetermined period is preferably a transmission inhibition period used when the transmission request signal was transmitted.

Furthermore, the present invention is a wireless communication method in which a carrier sense and an exchange of a transmission request signal and a transmission permission signal are performed in order to perform wireless communication. The wireless communication method includes the step of performing control so that, after a transmission request signal has been transmitted, even in a case where a signal in which a wireless communication apparatus other than a wireless communication apparatus itself is configured as a destination is received, retransmission is not performed for a predetermined period.

The present invention is a program for causing a computer to execute the above-described wireless communication method.

Furthermore, the present invention is a processing apparatus that causes a wireless communication apparatus to execute a predetermined function, and the wireless communication apparatus is used in a wireless communication system in which a carrier sense and an exchange of a transmission request signal and a transmission permission signal are performed in order to perform wireless communication. The predetermined function includes a control function in which, after a transmission request signal has been transmitted, even in a case where a signal in which a wireless communication apparatus other than the wireless communication apparatus itself is configured as a destination is received, retransmission is not performed for a predetermined period.

### Advantageous Effects of Invention

The present invention can reduce the occurrence of a data collision in the case where data and an RTS are simultaneously transmitted.

In addition, the occurrence of wasted time in the case where data and an RTS are simultaneously transmitted can be reduced.

### BRIEF DESCRIPTION OF DRAWINGS

FIG. 1 is a timing chart illustrating an example of the case where two STAs simultaneously acquire a transmission opportunity, two STAs (STA1) transmit data without an RTS/CTS exchange, and the other STA (STA2) performs an RTS/CTS exchange.

FIG. 2 illustrates an example of the overall configuration of a wireless communication system according to a first embodiment of the present invention.

FIG. 3 is a functional block diagram illustrating an example of the configuration of each of an AP and a STA.

FIG. 4 is a flowchart illustrating a flow of a process performed in the case where a STA connects to a network.

FIG. 5 is a flowchart illustrating a flow of a process performed in the case where the AP receives a connection request from a STA.

FIG. 6 is a flowchart illustrating a flow of a data reception process performed by the AP.

FIG. 7 is a flowchart illustrating a flow of a transmission process performed by a STA.

FIG. 8 is a timing chart illustrating an example of communication performed by using an access method used in IEEE802.11.

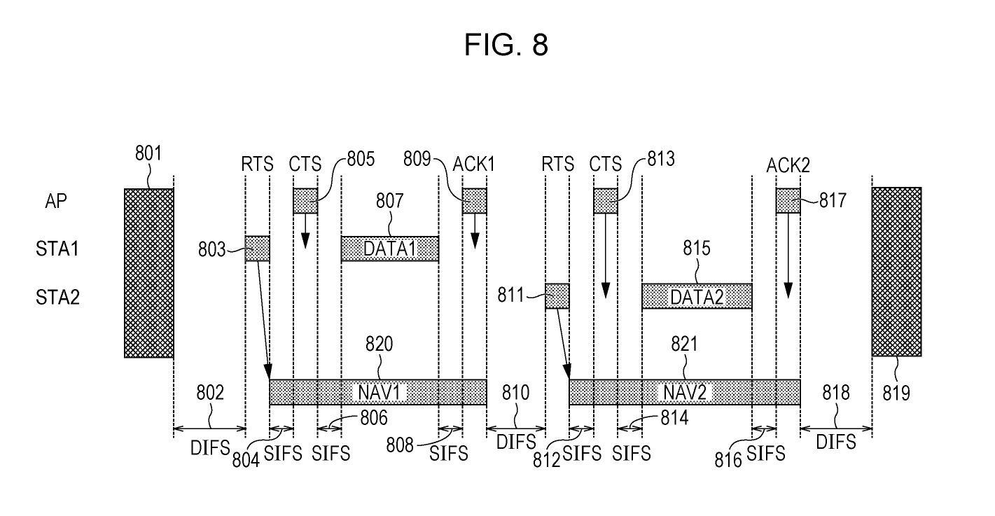

### DESCRIPTION OF EMBODIMENTS

A wireless communication technology according to an embodiment of the present invention will be described in detail below with reference to the drawings.

An embodiment of the present invention will be described in detail with reference to the drawings. In the embodiment, there will be described an example in which a DCF complying with an IEEE802.11 standard is performed with MU-MIMO in a network constituted by one AP and four STAs. The AP and the individual STAs have four antennas, and are capable of receiving a maximum of four streams of signals simultaneously.

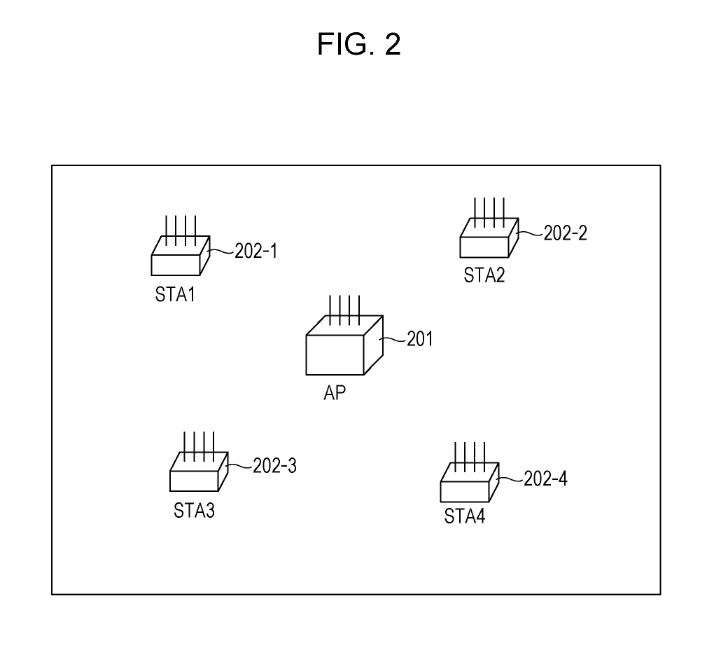

FIG. 2 illustrates an example of the general configuration of this wireless communication system. A wireless network illustrated in FIG. 2 includes one AP201 and four STAs202-1 to -4, which are STA1 to STA4.

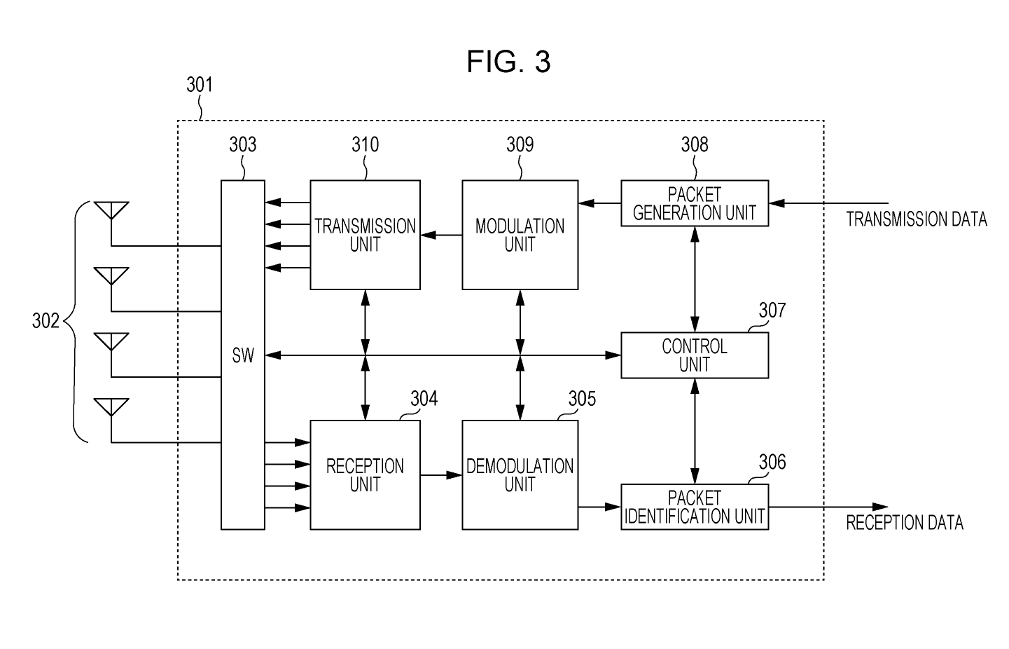

FIG. 3 is a functional block diagram illustrating an example of the configuration of each of the AP and a STA. As illustrated in FIG. 3, the AP and the STA each include a housing 301, an antenna unit 302 that is installed outside the housing 301 and constituted by four antennas for performing transmission and reception of RF signals, a switch (SW) unit 303 that switches a connection destination of an antenna to either a reception unit 304 or a transmission unit 310 in accordance with an instruction from a control unit 307, and the reception unit 304 that converts received RF signals into baseband signals, performs carrier sense on the baseband signals, notifies the control unit 307 of a result of the carrier sense, and also inputs the baseband signals to a demodulation unit 305.

Furthermore, the wireless communication system has the following configuration.

The demodulation unit 305 demodulates the input baseband signals on the basis of preconfigured information from the control unit 307. In a case that the configuration to perform MIMO demodulation is applied, patterns of preambles added to the beginnings of received signals are also configured, transfer functions between multiple transmission antennas and the antenna unit 302 installed on the housing are estimated by using the configured preamble patterns, and demodulation is performed. The preamble patterns and other transmission signals that comply with an IEEE802.11n standard are used. As a preamble pattern used by each STA, a sequence that is orthogonal between the STAs is used so that MIMO reception is performed in the AP.

As an example, a sequence using a time shift, such as a preamble pattern (HT-LTF) for MIMO used in the IEEE802.11n standard, can be used. In the embodiment, a MIMO demodulation method is not particularly limited, and various methods, such as a ZF (zero forcing) method, an MMSE (Minimum Mean Square Error) method, and an MLD (Maximum Likelihood Detection) method, can be used. In the embodiment, a maximum of four streams of signals can be demodulated by using four antennas. For this reason, a minimum of four types of preamble patterns have to be prepared. The estimated transfer functions are used for demodulation, and are also input to the control unit 307. demodulation results are input to a packet identification unit 306. In the case where MIMO demodulation is performed, demodulated streams are individually input to the packet identification unit 306.

The packet identification unit 306 performs identification of packets and error checks from signals demodulated by the demodulation unit 305. In the case where a packet including communication data is received successfully, the communication data is also output externally as reception data.

The control unit 307 is a block that overall controls and manages the AP, the STA, and the entire network. When a signal is to be received, the control unit 307 configures the switch unit 303, the reception unit 304, and the demodulation unit 305 in preparation for reception of the signal. In addition, when transmission data is input externally, or when transmission data for network management is generated within the control unit 307, the control unit 307 configures a packet generation unit 308, a modulation unit 309, the transmission unit 310, and the switch unit 303 to perform data transmission. Network management will be described later.

When transmission data is input externally, the packet generation unit 308 provides a notification to that effect to the control unit 307, and then generates transmission packet in a format specified by the control unit 307. The transmission packet is input to the modulation unit 309 as specified by the control unit 307. The modulation unit 309 is capable of generating a maximum of four modulated data simultaneously in accordance with an instruction from the control unit 307. In addition, in accordance with an instruction of the control unit 307, the modulation unit 309 is capable of generating preambles in a format specified by the control unit 307 before it modulates the input data. After the preambles have been transmitted, the modulation unit 309 modulates the input data with a modulation technique specified by the control unit 307, and transmits it to the transmission unit 310. The transmission unit 310 is a block that considers the modulated data input from the modulation unit 309 to be baseband signals and performs conversion and amplification of the baseband signals into RF signals to output it in accordance with an instruction from the control unit 307. The transmission unit 310 is capable of outputting a maximum of four RF signals in accordance with an instruction from the control unit 307. The output from the transmission unit 310 is transmitted from the antenna unit 302 via the switch unit 303.

In the embodiment, in network management, a method complying with the IEEE802.11 standard is used, and steps required for implementing the present invention will be described in more detail. Assignment of preamble patterns differing between the STAs, which is involved in the embodiment, is performed when each STA connects to the network.

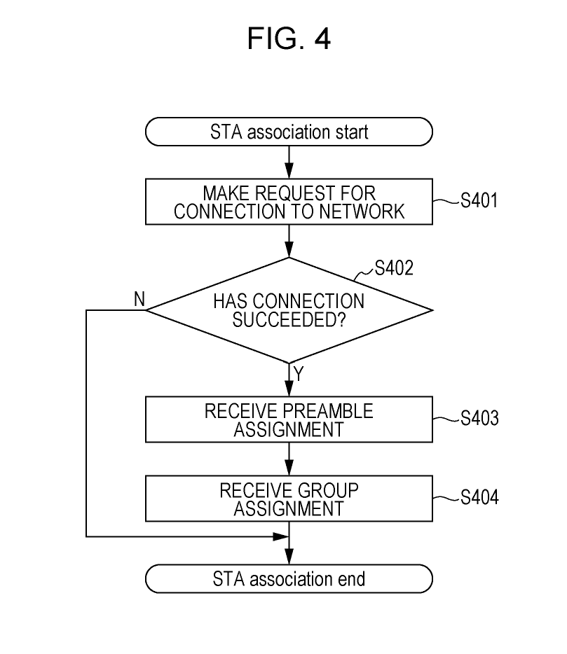

FIG. 4 illustrates a flow performed in the case where a STA connects to the network. First, the STA makes a connection request to the AP to which a connection is to be made in S401. This corresponds to an association request in the IEEE802.11 standard. Then, the STA receives the completion of the connection from the AP, and thereby determines whether or not the connection has succeeded in S402. In the case where the connection has failed (N), the STA considers that the AP is in a state in which a STA can no longer connect to the AP, and ends the connection process (end). In the case where the connection has succeeded (Y), the STA receives a preamble assignment transmitted from the AP in S403, and subsequently receives group assignment information representing which group includes the STA itself in S404. The AP can configure multiple STAs as destinations by using the assigned group numbers. Upon completion of reception of the group assignment information, the STA-side connection process ends (end).

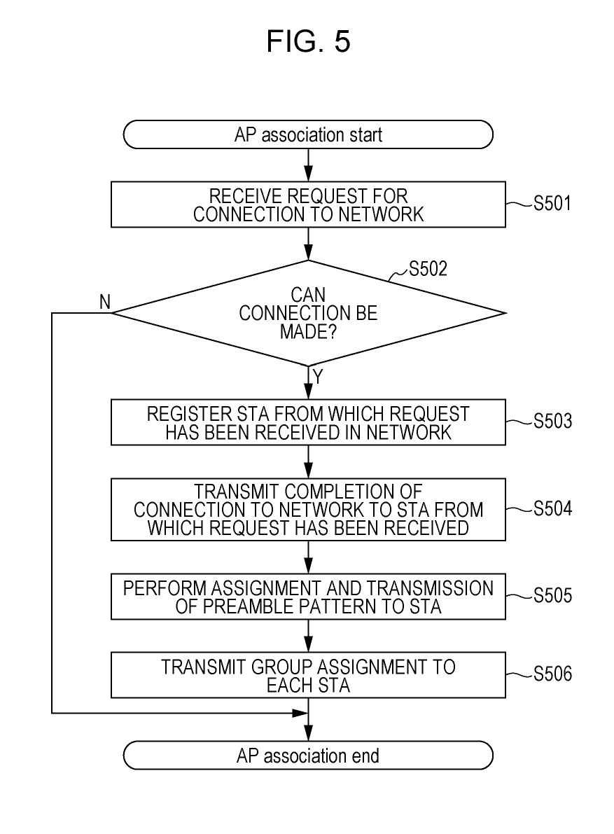

Next, FIG. 5 illustrates a flow performed in the case where the AP receives a connection request from a STA. First, the AP receives a connection request from the STA in S501. The connection request corresponds to an association request in IEEE802.11. The AP determines whether or not the STA can be registered in its network in S502, and, in the case where registration cannot be performed by the connection request (N), the AP ends the connection process without doing anything (end). In the case where registration can be performed by the connection request (Y), the AP proceeds to S503. A determination as to whether or not registration can be performed is made in accordance with the conditions as to whether or not, for example, a preamble pattern assignment and a group assignment can be made to the STA. The AP registers the STA having transmitted the connection request in the network in S503, and transmits the completion of the connection to the STA having transmitted the connection request in S504. This corresponds to an association response in IEEE802.11. Subsequently, the AP transmits preamble assignment information to the STA having transmitted the connection request in S505. Then, the AP transmits group assignment information to the STAs in S506, and ends the connection process (end).

In the connection request process described above, both of transmission from an AP side and transmission from a STA side are performed by using a method based on the DCF in IEEE802.11.

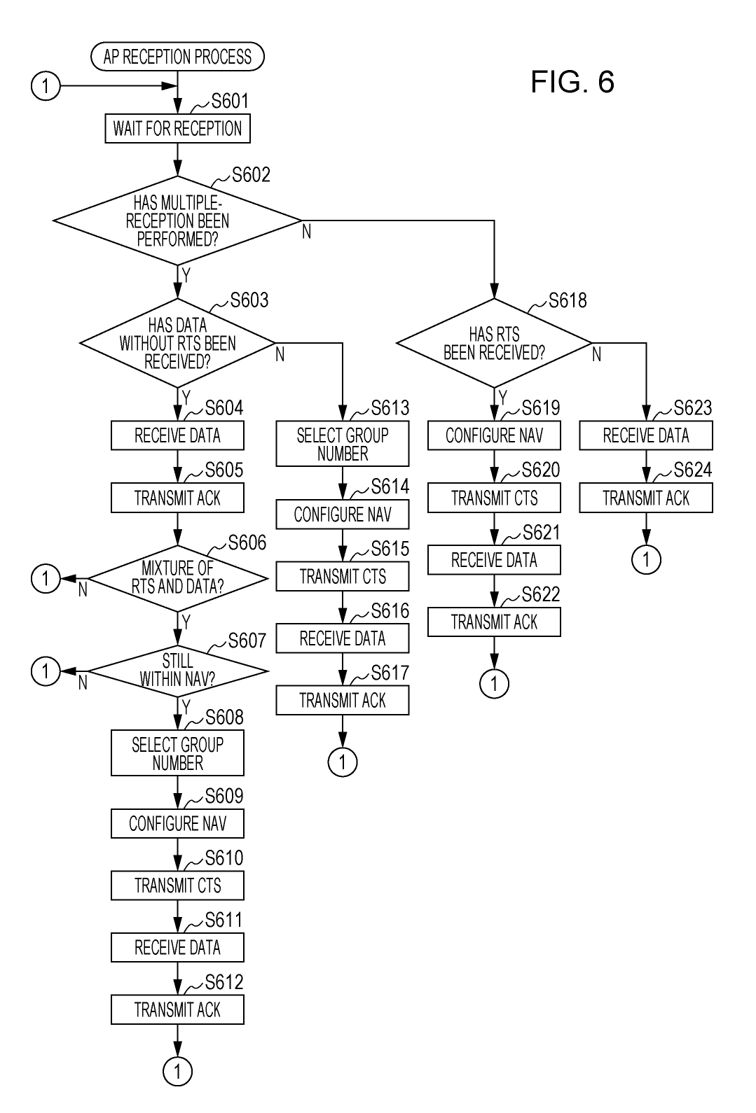

Next, a data reception flow performed by the AP will be described with reference to FIG. 6.

The AP is in a reception waiting state in S601, receives preambles and also proceeds to S602. The AP determines, in accordance with the fact as to whether or not multiple preamble patterns have been received, whether or not multiple streams have been received in S602. In the case where only one stream has been received (N), the AP proceeds to S618, and, in the case where multiple streams have been received (Y), the AP proceeds to S603. The AP determines whether or not there is a data packet transmitted without an RTS among the received streams in S603. In the case where there is no data packet transmitted without an RTS (N), the AP proceeds to S613, and, in the case where a data packet transmitted without an RTS is included (Y), the AP proceeds to S604. The AP demodulates the data packet transmitted without an RTS and takes reception data in S604, and transmits an ACK on the basis of a result of the reception in S605. In the case where there are multiple pieces of reception data in S604, the AP transmits as many ACKs as the number of pieces of received data.

Subsequently, the AP determines whether or not an RTS is included in the received streams in S606. In the case where no RTS is included (N), the AP returns to S601, and, in the case where an RTS is included (Y), the AP proceeds to S607. The AP determines whether or not a time immediately after an ACK has been transmitted is after the expiration of the longest NAV included in received RTSs in S607. In the case where the time is after the expiration of the NAV (N), the AP returns to S601, and, in the case where the time is within the NAV (Y), the AP proceeds to S608. This prevents transmission from being performed continuously after the expiration of a once-configured NAV.

The AP determines which STA the received RTS has been transmitted from and selects a group number to be used at the time of CTS transmission in S608. This can determine a STA that will perform transmission after CTS transmission. In the case where one STA has transmitted an RTS, not a group number but an address of the STA is used. Subsequently, the AP configures a NAV in S609. As a NAV to be configured, a value obtained by subtracting a period taken to transmit the RTS from the longest NAV among NAVs configured in the RTSs is used. The AP transmits a CTS using the configured group number or address of the STA and the configured NAV in S610. After the CTS transmission, data is transmitted from the specified STA, the AP therefore receives the data in S611, and transmits an ACK on the basis of a received result in S612. In the case where the AP receives multiple data streams in S611, the AP transmits multiple ACKs in S612. After the ACK transmission, the AP returns to S601.

In the case where there is no data packet transmitted without an RTS (N) in S603, the AP selects a group number as in S608 or selects an address of a STA in S613. Then, the AP configures a NAV in S614. A NAV to be configured is configured to a value obtained by subtracting a period taken to transmit an RTS from the longest NAV among NAVs transmitted by STAs selected as destinations. This extends a first configured NAV. Subsequently, the AP transmits a CTS including the selected group number or address of the STA and the configured NAV in S615. After the CTS transmission, data is transmitted from the configured STA, the AP therefore receives the data in S616, and transmits an ACK on the basis of a received result in S617. In the case where the AP receives multiple data streams in S616, the AP transmits multiple ACKs in S617. After the ACK transmission, the AP returns to S601.

In the case where no multiple preamble patterns have been received (N) in S602, the AP determines whether or not the received stream is an RTS in S618. In the case where the stream is not an RTS (N), the AP proceeds to S623, and, in the case where an RTS has been received (Y), the AP proceeds to S619. The AP configures a NAV in S619. A NAV to be configured here complies with 802.11 and is a value obtained by subtracting a period taken to transmit the RTS from a NAV included in the received RTS. Subsequently, the AP transmits a CTS including the configured NAV to a STA having transmitted the RTS in S620. Immediately after the CTS transmission, data is transmitted from the STA, the AP therefore receives the data in S621, transmits an ACK on the basis of a received result in S622, and returns to S601. In the case where no RTS has been received in S618, the AP receives data in S623, transmits an ACK on the basis of a received result in S624, and returns to S601.

The above is the flow of the reception process in the AP.

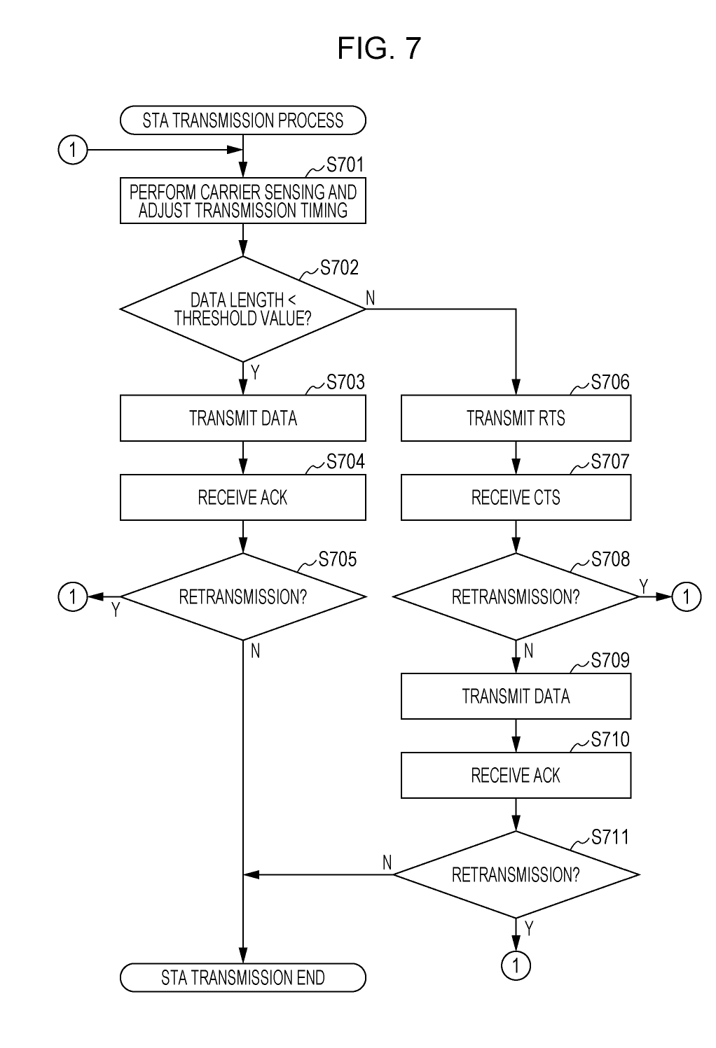

Next, a transmission flow performed by a STA will be described using FIG. 7. The STA performs a carrier sense and adjusts a transmission timing in S701. This transmission timing adjustment is made in order to perform MU-MIMO transmission, and the technique or the like disclosed in the above-described NPL 1 or PTL 1 can be used as an example. This increases the probability that multiple STAs will simultaneously perform transmission. In the case where the STA receives an RTS or CTS during the transmission timing adjustment, the STA does not perform transmission for a NAV period included in the RTS or CTS. In some cases, a new NAV is transmitted during a NAV period. In this case, the NAV received later updates the NAV period. The STA acquires a transmission timing, and then determines whether or not a period required to transmit data is smaller than a predetermined threshold value in S702. As an example of this predetermined threshold value, a value of dot11RTSThereshold is used in IEEE802.11, and the predetermined threshold value complies with this in the embodiment as well. In the case where the period is smaller than this predetermined threshold value (Y), the STA proceeds to S703, and, in the case where the period is more than or equal to the threshold value (N), the STA proceeds to S706.

In the case where the period is smaller than the threshold value, the STA starts to transmit the data in S703. After the data transmission, the STA waits until an ACK is received in S704. The STA determines whether or not retransmission is required in S705. Retransmission is performed only in the case where an ACK transmitted from the AP is unable to be received within a predetermined period and where retransmission was performed not more than a predetermined number of times in the past. For example, there is considered a method in which a period equal to dot11RTSThreshold in IEEE802.11 is used as the predetermined period and in which a Short Retry Count in IEEE802.11 is used as the predetermined number of times. In the case where retransmission is not performed, the STA considers transmission successful if it has received an ACK, considers transmission unsuccessful if it has been unable to receive an ACK, and ends the transmission process.

In the case where a period required to transmit data is more than or equal to the threshold value (N) in S702, the STA transmits an RTS in which the period required to transmit the data is configured as a NAV in S706. Then, the STA receives a CTS transmitted from the AP in S707. Subsequently, the STA determines, in accordance with the fact as to whether or not a CTS has been received within a predetermined period, whether or not retransmission of the RTS is to be performed in S708. As an example of the predetermined period, dot11RTSThreshold in IEEE802.11 or the NAV configured at the time of the RTS transmission can be used. This is because the case where another STA has transmitted data at the same time is considered. In such a case, if retransmission is determined during a SIFS period after the RTS transmission as in IEEE802.11, retransmission is performed while the other STA is transmitting data. Even in the case where a CTS has not been received after the predetermined period, if it is determined, through carrier sensing, that another STA is performing transmission, after that STA has performed transmission, the STA waits for a CTS to be transmitted or not after a SIFS period, and determines whether or not the CTS has been received.

In the case where a CTS has not been received within the predetermined period, the STA returns to S701 so as to retransmit the RTS (Y). In the case where a CTS has been received within the predetermined period (N), the STA transmits the data in S709, and then receives an ACK in S710. After the data transmission, in the case where an ACK has not been received within a predetermined period, the STA determines whether or not retransmission is to be performed in S701. As this predetermined period, a NAV configured in the CTS is used. Because, in some cases, the AP transmits ACKs individually in the case where the AP receives multiple pieces of data, when the AP is transmitting an ACK to another STA, the STA then waits for an ACK to be transmitted or not from the AP after a SIFS period and checks whether or not an ACK towards the STA itself is transmitted while the AP is transmitting ACKs. Retransmission is performed up to a predetermined number of times. As an example of this predetermined number of times, a Shot Retry Count in IEEE802.11 can be used. In the case where retransmission is performed, the STA returns to S701. In the case where retransmission is not performed (N), the STA considers transmission successful if it has received an ACK, considers transmission unsuccessful if it has been unable to receive an ACK (Y), and ends the transmission process.

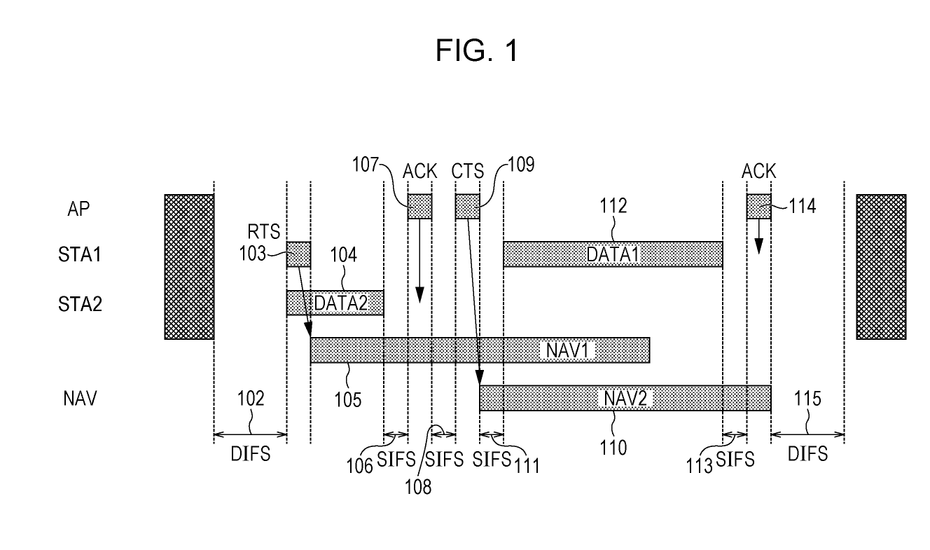

An AP and STAs operate as described above, and thus, in the case where an RTS and data are simultaneously transmitted from multiple STAs, transmission of an ACK and transmission of a CTS can be performed while updating a NAV. FIG. 1 is a timing chart illustrating an example of the case where two STAs simultaneously acquire a transmission opportunity, one STA (STA1) transmits data without an RTS/CTS exchange, and the other STA (STA2) performs an RTS/CTS exchange.

First, the timing chart begins when transmission 101 performed by an AP or either STA is completed. When a DIFS period 102 elapses since the transmission 101 performed by the AP or either STA has been completed, a STA1 transmits an RTS 103 and a STA2 transmits a data packet DATA2 104. A NAV1 105 period is configured in the RTS 103. The AP demodulates the RTS 103 and the DATA2 104 that have been transmitted from two STAs, and transmits an ACK 107 to the STA2 after a SIFS period 106 has elapsed since reception of the DATA2 104 was completed. At this time, the AP refers to the NAV1 105 configured in the RTS 103, and determines whether or not it has a period to transmit a CTS to the STA1 having transmitted the RTS 103. In this example, the AP has a period to transmit a CTS, and therefore transmits a CTS 108 to the STA1 after a CIFS period 108 has elapsed since the ACK 107 was transmitted.

A NAV to be configured when this CTS 108 is transmitted is a NAV2 110 obtained by subtracting a period taken to transmit the RTS 103 from the NAV1 105 included in the RTS 103 transmitted by the STA1. This extends the NAV, and enables the STA1 to have a period required to transmit data. The STA1 having received the CTS 108 transmits DATA1 112 to the AP after a SIFS period 111 has elapsed. The AP having received the DATA1 112 transmits an ACK 114 to the STA1 after a SIFS period 113 and ends a series of processes. A period specified in the NAV2 110 also ends with the completion of transmission of this ACK 114, then a DIFS period 115 elapses, and then subsequent DCF access 116 can be started.

As described above, in the case where multiple STAs transmit data and an RTS simultaneously, an ACK and a CTS are transmitted within a NAV period configured in the RTS, thereby enabling an AP to perform prioritized transmission by using the NAV period included in the RTS. In addition, a NAV newly configured in the CTS extends the NAV period, and data transmission from a specified STA can be performed on a priority basis, thereby making it possible to control the conditions in which data transmission and RTS transmission are simultaneously performed without wasting time.

In the embodiment, the case where each STA transmits only one stream has been described; alternatively, the STA may transmit multiple streams within the transmission capabilities of the AP. To do this, it is recommended that assignments of multiple preamble patterns are received, and that, in the case where multiple streams are transmitted by using multiple antennas, the different preamble patterns are used for signals to be transmitted from the individual antennas and thus transfer functions between the individual antennas and individual antennas of the AP can be obtained. In the above-described embodiment, the configuration and so forth illustrated in the accompanying drawings are not limited thereto, and can be appropriately changed within the scope of exhibiting the effects of the invention. In addition, the configuration and so forth can be appropriately changed and implemented without departing from the scope of the objects of the present invention. Furthermore, selections can optionally be made from the components of the present invention, and an invention having the selected components is also within the scope of the present invention.

Furthermore, a processing apparatus that causes an apparatus to execute a predetermined function may be provided.

Furthermore, a program for implementing the functions described in the embodiment may be recorded in a computer-readable recording medium, and the process in each unit may be performed by causing a computer system to read and execute the program recorded in this recording medium. It is noted that the “computer system” here includes an OS, and hardware, such as peripheral devices.

Furthermore, in the case where a WWW system is used, the “computer system” also includes a website-providing environment (or display environment).

Furthermore, “computer-readable recording media” are portable media, such as a flexible disk, a magneto-optical disk, a ROM, and a CD-ROM, and a storage device, such as a hard disk built into the computer system. Moreover, among the “computer-readable recording media” there are also included a medium that dynamically holds a program for a short time period like a line of communication used in the case where a program is transmitted via a network, such as the Internet, or a communication line, such as a telephone line, and a medium that holds a program for a certain time period like a volatile memory provided in a computer system serving as a server or client for that case. Also, the above-described program may be a program for implementing part of the above-described functions, and may be a program that can implement the above-described functions in combination with a program already recorded in the computer system. At least part of the functions may be implemented by hardware, such as an integrated circuit.

### INDUSTRIAL APPLICABILITY

The present invention is applicable to a communication apparatus.

### REFERENCE SIGNS LIST

301 housing of AP
302 antenna unit
303 switch (SW) unit
304 reception unit
305 demodulation unit
306 packet identification unit
307 control unit
308 packet generation unit
309 modulation unit
310 transmission unit

1-11. (canceled)

12. A wireless communication apparatus used in a wireless communication system in which a carrier sense, and an exchange of a transmission request signal and a transmission permission signal are performed in order to perform wireless communication, the wireless communication apparatus comprising:
a reception unit that is capable of receiving multiple signals simultaneously; and
a control unit that generating an acknowledgement response to a data signal on a priority basis
in a case where the data signal and a transmission request signal are included in signals received by the reception unit.

13. The wireless communication apparatus according to claim 12,
wherein, in a case where a transmission inhibition period included in the transmission request signal is larger than a predetermined value, after the acknowledgement response to the data signal has been made, the control unit transmits a transmission permission signal corresponding to the transmission request signal.

14. The wireless communication apparatus according to claim 13, wherein, at a time when the control unit transmits the transmission permission signal, the control unit includes, in the transmission permission signal, a value obtained by subtracting a predetermined value from the transmission inhibition period included in the transmission request signal, and transmits the transmission permission signal.

15. A wireless communication method in which a carrier sense and an exchange of a transmission request signal and a transmission permission signal are performed in order to perform wireless communication, the wireless communication method comprising the step of,
in a case where signals including a data signal and a transmission request signal are received, generating an acknowledgement response to the data signal on a priority basis.

16. A wireless communication apparatus used in a wireless communication system in which carrier sensing, and an exchange of a transmission request signal and a transmission permission signal are performed in order to perform wireless communication, the wireless communication apparatus comprising
a control unit that performs control so that, after a transmission request signal has been transmitted, in a case where data transmission is unable to be performed, even in a case where a signal in which a wireless communication apparatus other than the wireless communication apparatus itself is configured as a destination is received, retransmission is not performed for a predetermined period.

17. The wireless communication apparatus according to claim 16,
wherein the predetermined period is a transmission inhibition period used when the transmission request signal was transmitted.
